(19) United States
(12) Patent Application Publication
(10) Pub. No.: US 2025/0385877 A1
(43) Pub. Date: Dec. 18, 2025

(54) SELECTIVE ADAPTIVE ROUTING

(71) Applicant: MELLANOX TECHNOLOGIES, LTD., Yokneam (IL)

(72) Inventors: Amit Kazimirsky, Givat-Shmuel (IL); Eran Gil Beracha, Tel Aviv (IL)

(21) Appl. No.: 18/746,734

(22) Filed: Jun. 18, 2024

(51) Int. Cl. H04L 49/25; H04L 49/505

(52) U.S. Cl. CPC H04L 49/256; H04L 49/505

(57) ABSTRACT

Systems, devices, and methods are provided. In one example, a system is described that includes circuits to route data using a first adaptive routing technique; detect a ratio of ingress flows to egress flows is below a threshold; and in response to detecting the ratio of ingress flows to egress flows is below the threshold, switch from routing the data using the first adaptive routing technique to routing the data using a second adaptive routing technique.

### FIELD OF THE DISCLOSURE

The present disclosure is generally directed toward networking and, in particular, toward networking devices and methods of operating the same.

### BACKGROUND

Switches and similar network devices represent a core component of many communication, security, and computing networks. Switches are often used to connect multiple devices to form networks.

Devices including but not limited to personal computers, servers, and other types of computing devices, may be interconnected using network devices such as switches. Such interconnected entities may form a network enabling data communication and resource sharing among the nodes. Often multiple potential paths for data flow may exist between any pair of devices. This allows data to traverse different routes from a source device to a destination device. Such a network design enhances the robustness and flexibility of data communication as it provides alternatives in case of path failure, congestion, or other adverse conditions. Moreover, such a network design facilitates load balancing across the network, optimizing the overall network performance and efficiency.

### BRIEF SUMMARY

In accordance with one or more embodiments described herein, a computing system, such as a switch, may enable a diverse range of systems, such as switches, servers, personal computers, and other computing devices, to communicate across a network. Ports of the computing system may function as communication endpoints, allowing the computing system to manage multiple simultaneous network connections with one or more nodes. The computing system, which may be referred to herein as a switch, may perform one or more methods involving the routing of data using one or more adaptive routing techniques. Such adaptive routing techniques, as described in greater detail herein, may include a spray adaptive routing technique in which the data is broadcast across all available uplink ports and a sticky adaptive routing technique in which flows of the data are actively managed and allocated to specific ports. The specific adaptive routing technique used at any given time may be selected based on one or more factors by a system or via a method as described in greater detail herein.

The present disclosure describes systems and methods for enabling a switch or other computing system to select and switch between different adaptive routing techniques based on events and/or factors within the switch and/or a network. As an illustrative example aspect of the systems and methods disclosed, a system may include one or more circuits to route data using a first adaptive routing technique, detect a ratio of ingress flows to egress flows is below a threshold, and in response to detecting the ratio of ingress flows to egress flows is below the threshold, switch from routing the data using the first adaptive routing technique to routing the data using a second adaptive routing technique.

The above example aspect system includes one or more of wherein the one or more circuits are further to measure a current bandwidth and compare the current bandwidth to a bandwidth threshold, wherein detecting the ratio of ingress flows to egress flows is below the threshold is performed in response to determining the current bandwidth is lower than the bandwidth threshold, wherein routing the data using the first adaptive routing technique comprises forwarding packets across a plurality of active ports, wherein the second adaptive routing technique comprises allocating a single port for each of one or more flows of the data, wherein switching from routing the data using the first adaptive routing technique to routing the data using the second adaptive routing technique comprises generating a request and sending the request to a destination, wherein the destination is a top-of-rack switch, wherein after switching to routing the data using the second adaptive routing technique, one or more ports enter a sleep mode, wherein, after switching to routing the data using the second adaptive routing technique, the one or more circuits are further to: determine a total bandwidth is greater than a total bandwidth threshold and in response to determining the total bandwidth is greater than the total bandwidth threshold switch the routing of the data from the second adaptive routing technique to the first adaptive routing technique, and wherein the ratio of ingress flows to egress flows is associated with a port of the system.

In another illustrative example, a system includes one or more circuits to route one or more egress flows of packets using a first adaptive routing technique, detect a ratio of ingress flows to the one or more egress flows is below a threshold, and in response to detecting the ratio of ingress flows to the one or more egress flows is below the threshold, switch from routing the one or more egress flows of packets using the first adaptive routing technique to routing the one or more egress flows of packets using a second adaptive routing technique.

The above example aspect switch includes one or more of wherein the one or more circuits are further to measure a current bandwidth and compare the current bandwidth to a bandwidth threshold, wherein detecting the ratio of ingress flows to egress flows is below the threshold is performed in response to determining the current bandwidth is lower than the bandwidth threshold, wherein routing the data using the first adaptive routing technique comprises forwarding packets across a plurality of active ports, wherein the second adaptive routing technique comprises allocating a single port for each of one or more flows of the data, wherein switching from routing the data using the first adaptive routing technique to routing the data using the second adaptive routing technique comprises generating a request and sending the request to a destination, wherein the destination is a top-of-rack switch, wherein after switching to routing the data using the second adaptive routing technique, one or more ports enter a sleep mode, wherein, after switching to routing the data using the second adaptive routing technique, the one or more circuits are further to: determine a total bandwidth is greater than a total bandwidth threshold and in response to determining the total bandwidth is greater than the total bandwidth threshold switch the routing of the data from the second adaptive routing technique to the first adaptive routing technique, and wherein the ratio of ingress flows to egress flows is associated with a port of the system.

In yet another illustrative example, a method for providing adaptive routing includes routing data using a first adaptive routing technique, detecting a ratio of ingress flows to egress flows is below a threshold, and in response to detecting the ratio of ingress flows to egress flows is below the threshold, switching from routing the data using the first adaptive routing technique to routing the data using a second adaptive routing technique.

The above example method includes wherein the method further comprises measuring a current bandwidth and comparing the current bandwidth to a bandwidth threshold, and wherein detecting the ratio of ingress flows to egress flows is below the threshold is performed in response to determining the current bandwidth is lower than the bandwidth threshold.

The routing approaches depicted and described herein may be applied to a switch, a router, or any other suitable type of networking device known or yet to be developed. Additional features and advantages are described herein and will be apparent from the following description and the figures.

### BRIEF DESCRIPTION OF THE SEVERAL VIEWS OF THE DRAWINGS

The present disclosure is described in conjunction with the appended figures, which are not necessarily drawn to scale:

FIG. 1 is a block diagram depicting an illustrative configuration of a computing system in accordance with at least some embodiments of the present disclosure;

FIG. 2 illustrates a network of computing systems and nodes in accordance with at least some embodiments of the present disclosure; and

FIG. 3 is a flow diagram depicting a method in accordance with at least some embodiments of the present disclosure;

FIG. 4 is a flow diagram depicting a method in accordance with at least some embodiments of the present disclosure;

FIG. 5 is a flow diagram depicting a method in accordance with at least some embodiments of the present disclosure; and

FIG. 6 is a flow diagram depicting a method in accordance with at least some embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate,” “compute,” and variations thereof, as used herein, are used interchangeably, and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

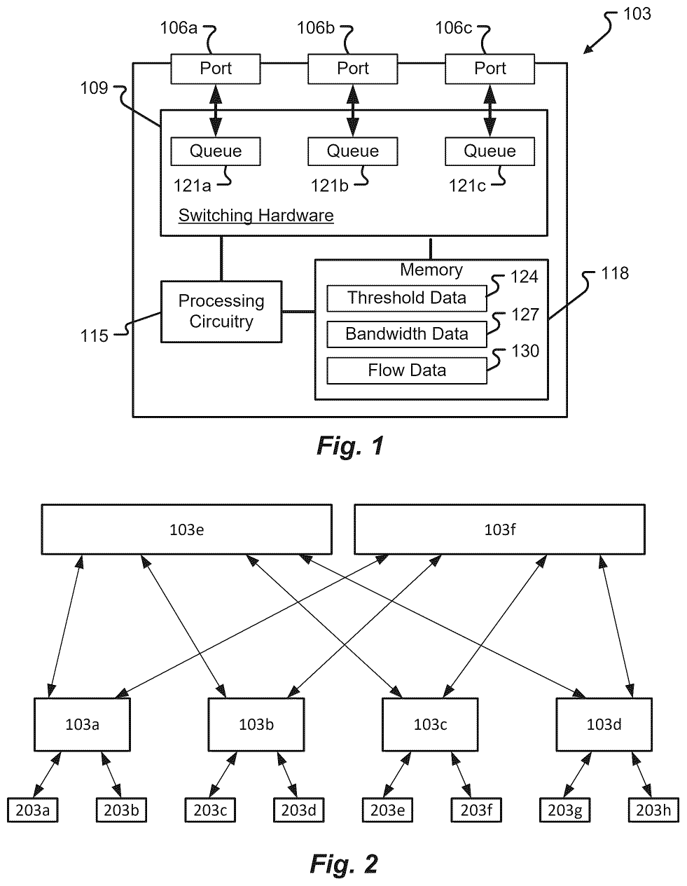

Referring now to FIGS. 1-6, various systems and methods for routing packets between switches and nodes will be described. The concepts of packet routing depicted and described herein can be applied to the routing of information from one computing device to another. The term packet as used herein should be construed to mean any suitable discrete amount of digitized information. The data being routed may be in the form of a single packet or multiple packets without departing from the scope of the present disclosure. Furthermore, certain embodiments will be described in connection with a system that is configured to make centralized routing decisions whereas other embodiments will be described in connection with a system that is configured to make distributed and possibly uncoordinated routing decisions. It should be appreciated that the features and functions of a centralized architecture may be applied or used in a distributed architecture or vice versa.

As illustrated in FIG. 1, a switch 103 as described herein may be a computing system including a number of ports 106a-c. The ports 106a-c may be used to connect the switch 103 with other switches 103, computing systems, and/or network devices. The switch 103 as well as any other switches 103, computing systems, and/or network devices may be referred to as nodes. The interconnected switches 103, computing systems, and/or network devices form a network. For example, and as illustrated in FIG. 2, a switch 103 may operate as a spine switch 103e, 103f, a leaf switch 103a-d, or a switch 103 of a different level, and may connect to other switches 103 and/or nodes 203a-h. Such a network of switches 103 and nodes 203 may be useful in various settings, from data centers and cloud computing infrastructures to artificial intelligence systems.

Switches 103, as described in greater detail herein, may enable communication between switches 103 and/or nodes 203. A switch 103 may be, for example, a switch, a network interface controller (NIC), or other device capable of receiving and sending data, and may act as a central node in the network. Switches 103 may be wired in a topology including spine switches, top-of-rack (TOR) switches, and/or leaf switches, for example. A TOR switch, for example, any suitable type of type of networking device that connects multiple computers in a single physical location. As the name implies, a TOR switch is typically installed at the top of a rack in a data centers or other large network. Switches 103 may be capable of receiving, processing, and forwarding data, e.g., packets, to appropriate destinations within the network, such as other switches 103 and/or nodes 203. In some implementations, a switch 103 may be included in a switch box, a platform, or a case which may contain one or more switches 103 as well as one or more power supply devices and other components.

In some implementations, a switch 103 may comprise one or more ports 106a-c connected to one or more ports of other switches 103 and/or nodes 203. Processes, such as applications executed by nodes 203 may involve transmitting data to other nodes 203 of the network via switches 103. Data may flow through the network of switches 103 and nodes 203 using one or more protocols such as transmission control protocol (TCP), user datagram protocol (UDP), or Internet protocol (IP), for example. Each switch 103 may, upon receiving data from a node 203 or another switch 103 examine the data to identify a destination for the data and route the data through the network.

A switch 103 may implement adaptive routing by selecting a port or ports 106 via which to route a given packet or flow of data through the network. Adaptive routing as described herein may involve the switch 103 dynamically selecting a port 106 for transmitting data packets. The port 106 may be selected based at least in part on an adaptive routing technique in effect at any given time. The particular system and method implementations of the present disclosure are described in relation to two adaptive routing techniques, i.e., a sticky adaptive routing technique and a spray adaptive routing technique. However, it should be appreciated that the same or similar systems and methods may be used for additional or alternative implementations in which other adaptive routing techniques are utilized. The present disclosure should not be considered as limited to any particular adaptive routing technique.

In a sticky adaptive routing technique, the switch 103 may allocate one or more ports to each flow traversing the switch. While the allocation of port(s) to flow(s) may change over time, at any given time, packets of a given flow will be forwarded via the port or ports allocated to that flow. The allocation of any given port or ports to any given flow may be made based on any number of factors, such as current traffic conditions, historical data, predictive analysis, and/or port congestion. The present disclosure should not be considered as limited to the use of a sticky adaptive routing technique utilizing any of these factors or any other factor.

In a spray adaptive routing technique, the switch 103 may distribute packets from one or more flows across one or more ports. In some implementations, a spray adaptive routing technique may involve forwarding packets from any flow traversing the switch to any available port. As an example, the specific port used to forward any given packet may be selected by the switch 103 using round robin or another algorithm; however, the present disclosure should not e considered as being limited to the use of any particular algorithm to implement a spray adaptive routing technique as described herein.

While the spray adaptive routing technique may be successful in achieving maximum performance and avoiding congestion, the sticky adaptive routing technique ensures traffic is routed in the best possible direction while enabling ports to enter a sleep mode during periods of low traffic. By dynamically switching between sticky and spray adaptive routing techniques in response to real-time factors, a switch 103 may be enabled to reduce overall power consumption.

Through the use of adaptive routing, traffic may be spread between a minimum number of necessary ports or links while unnecessary ports and/or entire switches or other devices may be deactivated to improve power efficiency. Conventional adaptive routing involves evenly spreading traffic across all ports of a switch, which results in a maximum amount of hardware being involved at all times. When a port is not being used, i.e., when both sides cease sending traffic over the port, the port and related hardware can enter into a sleep mode using the L1 mechanism. As a result of conventional adaptive routing, ports remain active while underutilized and do not enter into the sleep mode, failing to take advantage of power efficiencies which can be achieved through the systems and methods described herein which enable the adaptive routing technique being used by a switch 103 to switch from a spray adaptive routing technique to a sticky adaptive routing technique.

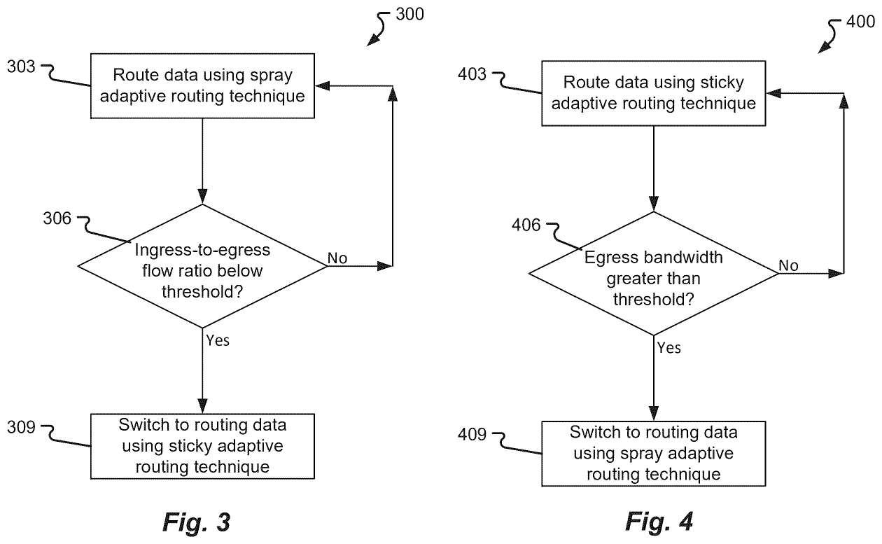

As described herein, a switch 103 may be capable of dynamically switching between two or more adaptive routing techniques by making decisions based on factors associated with a network and/or the flows of data traversing the switch 103. In some implementations, such decisions may be made by comparing variables such as egress bandwidth, numbers of ingress flows, numbers of egress flows, and/or other information to each other as well as to one or more thresholds, as described in greater detail below in relation to the methods 300, 400, 500, and 600 illustrated in FIGS. 3-6.

Each node 203 may be a computing unit, such as a personal computer, server, or other computing device, and may be responsible for executing applications and performing data processing tasks. Nodes 203 as described herein may range from servers in a data center to desktop computers in a network, or to devices such as internet of things (IoT) sensors and smart devices as examples.

Each node 203 may for example include one or more processing circuits, such as graphics processing units (GPUs), central processing units (CPUs), application-specific integrated circuits (ASICs), field programmable gate arrays (FPGAs), or other circuitry capable of performing computations, as well as memory and storage resources to run software applications, handle data processing, and perform specific tasks as required. In some implementations, nodes 203 may also or alternatively include hardware such as GPUs for handling intensive tasks for machine learning, artificial intelligence (AI) workloads, or other complex processes.

For example, nodes 203 communicating via switches 103 may operate as a high-performance computing (HPC) cluster. A cluster of nodes 203 may comprise numerous interconnected servers, each equipped with CPUs and/or GPUs. The nodes 203 may provide computational horsepower for, as an example, training large-scale AI models or running complex scientific simulations. For AI and machine learning tasks, the nodes 203 may comprise one or more GPUs or other processing circuitry which may be capable of handling parallel processing requirements of neural networks and other applications.

Nodes 203 may be client devices which, for example, engage in AI-related, research-related, and other processor-intensive tasks, and utilize a network of switches 103 and other nodes 203 to handle the computational loads and data throughput required by such intensive applications. Such nodes 203 may include, for example, workstations and personal computers used by researchers, data scientists, and professionals for developing, testing, and running AI models and research simulations.

A switch 103 as described herein may in some implementations be as illustrated in FIG. 1. Such a switch 103 may include a plurality of ports 106a-c, queues 121a-c, switching hardware 109, processing circuitry 115, and memory 118. The ports 106a-c of a switch 103 may be capable of facilitating the transmission of data packets, or non-packetized data, into, out of, and through the switch 103. Such ports 106a-c may serve as interface points where network cables may be connected, connecting the switch 103 with other switches 103, and/or nodes 203.

Each port 106 may be capable of receiving incoming data packets from other devices and/or transmitting outgoing data packets to other devices. In some implementations, ports 106 may be configured to operate as either dedicated ingress or egress ports 106 or may be enabled to operate in a dual functionality capable of performing ingress and egress functions. For example, an egress port 106 may be used exclusively for sending data from the interconnect device and an ingress port 106 may be used solely for receiving incoming data into the switch.

Switching hardware 109 of a switch 103 may be capable of handling a received packet by determining a port 106 from which to send the packet and forwarding the packet from the determined port 106. Using a system or method as described herein, switching hardware 109 may be capable of dynamically switching between different adaptive routing techniques based on factors associated with the performance of the switch 103 and/or a network of which the switch 103 is a part.

Each port 106 of a switch 103 may be associated with one or more queues 121a-c. When a packet, or data in any format, is to be sent from a port 106, the packet may be stored in a queue 121 associated with the port 106 until the port 106 is ready to send the packet. When congestion occurs, a backlog of data in queues 121 may build. By monitoring an amount of data in each queue, as described herein, the switch 103 may be enabled to determine an egress bandwidth associated with each queue 121 and/or an egress bandwidth associated with the ports 106 associated with the queues 121.

In support of the functionality of the switching hardware 109, processing circuitry 115 may be configured to control aspects of the switching hardware 109 to perform adaptive routing in relation to one or more adaptive routing techniques. The processing circuitry 115 may in some implementations include a CPU, an ASIC, and/or other processing circuitry which may be capable of handling computations, decision-making, and management functions required for operation of the switch 103.

Processing circuitry 115 may be configured to handle management and control functions of the switch 103, such as setting up routing tables, configuring ports, and otherwise managing operation of the switch 103. Processing circuitry 115 may execute software and/or firmware to configure and manage the switch 103, such as an operating system and management tools. In some implementations, the processing circuitry 115 may be configured to dynamically switching between different adaptive routing techniques based on factors associated with the performance of the switch 103 and/or a network of which the switch 103 is a part by communicating with one or more external devices such as other switches 103 and/or nodes 203. Processing circuitry 115 may further be capable of adjusting threshold data 124, bandwidth data 127, and/or flow data 130 as factors affecting the switching hardware 109 change and instructing the switching hardware 109 to function in accordance with a particular adaptive routing technique.

Memory 118 of a switch 103 as described herein may comprise one or more memory elements capable of storing configuration settings, threshold data 124, bandwidth data 127, flow data 130, application data, operating system data, and other data. Such memory elements may include, for example, random access memory (RAM), dynamic RAM (DRAM), flash memory, non-volatile RAM (NVRAM), ternary content-addressable memory (TCAM), static RAM (SRAM), and/or memory elements of other formats.

To enable adaptive routing technique decision-making capabilities, a switch 103 may store threshold data 124, bandwidth data 127, flow data 130 and/or other data in memory 118. Threshold data 124 may contain threshold levels which may be user-configurable and may be used in relation to real-time bandwidth, flow, and/or other factors to determine whether the switch 103 should switch adaptive routing techniques as described in greater detail below. Bandwidth data 127 may contain information relating to the bandwidth of egress traffic being forwarded by the switch 103 in real-time and/or historically. Such bandwidth data 127 may be used in relation to real-time flow data and/or other factors, as well as to threshold data 124, to determine whether the switch 103 should switch adaptive routing techniques as described in greater detail below. Flow data 130 may contain information relating to any flows of data currently and/or historically traversing the switch 103. Such flow data 130 may be used in relation to real-time bandwidth and/or other factors, as well as to threshold data 124, to determine whether the switch 103 should switch adaptive routing techniques as described in greater detail below.

As illustrated in FIG. 2, a number of switches 103a-f may be interconnected and also connected to nodes 203a-h to form a network. Each arrow in FIG. 2 may represent any number of one or more connections between the various elements. For example, ports of a first switch 103a may be connected to one or more ports of a second switch 103e, one or more ports of a third switch 103f, and one or more ports of each of nodes 203a and 203b. Each connection between a switch 103 and another switch 103 or node 203 may be used to carry multiple flows. Flows may also be static flows or adaptive routing flows. Static flows may be flows which cannot be rerouted via different routes through the network while adaptive routing flows may be flows which can be routed via a variety of different routes to reach the proper destination. As an example, each node 203a-h may transmit static flows and/or adaptive flows to other nodes 203a-h via the switches 103a-f.

As should be appreciated, the specific interconnections of the switches 103a-f and nodes 203a-h illustrated by FIG. 2 are provided for illustration purposes only and should not be considered as limiting in any way. While the network illustrated in FIG. 2 only includes 2 layers of switches 103, it should be appreciated additional layers may be introduced and switches may be interconnected in any conceivable manner. For example, in some implementations, a network as described herein may contain multiple switches 103 interconnected in a topology such as a Clos network or a fat tree topology network.

As illustrated in FIG. 3, a switch 103 may perform a method 300 involving dynamically switching from routing data using a first adaptive routing technique to routing data using a second adaptive routing technique. In the example method 300 illustrated in FIG. 3, the method 300 involves switching from a spray adaptive routing technique to a sticky adaptive routing technique in response to determining an ingress-to-egress flow ratio is below a flow ratio threshold. However, it should be appreciated that similar methods may be implemented to switch to and from different adaptive routing techniques and/or in response to other factors and determinations.

The method 300 may begin at 303, in which a switch 103 is routing data using a spray adaptive routing technique as described above. As referenced above, routing the data using a spray adaptive routing technique may involve forwarding packets across a plurality of active ports. As new packets traversing the switch 103 are handled and prepared for transmission, each packet may be assigned to a port without allocating one or more ports to any specific flows. It should be appreciated, however, that in some implementations certain flows may be handled using one adaptive routing technique (e.g., a spray adaptive routing technique) while other flows may be handled using another routing technique (e.g., a sticky adaptive routing technique). In such implementations, the method 300 may be used to dynamically switch the adaptive routing techniques for any number of one or more flows traversing the switch, if not all flows.

At 306, the switch 103 may determine whether an ingress-to-egress flow ratio is below a flow ratio threshold. An ingress-to-egress flow ratio may be calculated by dividing a number of unique source IP addresses observed on ingress ports 106 of the switch 103 by a number of unique source IP addresses observed on egress ports 106 of the switch 103. This calculation may be represented as num_dest_ip_x from received ports/num_source_ip_x to sent ports.

Determining whether the ingress-to-egress flow ratio is below the flow ratio threshold may include monitoring ingress and egress traffic. For example, the switch 103 may record source and/or destination IP addresses of packets received and transmitted by the switch 103. The switch 103 may maintain a count of such IP addresses and use the count of IP addresses to make the determination as to whether the ingress-to-egress flow ratio is below the flow ratio threshold.

In some implementations, determining the num_dest_ip_x from received ports and/or num_dest_ip_x to sent ports may involve polling contents of one or more queues 121. The determination of the num_dest_ip_x from received ports and/or num_dest_ip_x to sent ports may be performed by switching hardware 109 of the switch 103, processing circuitry 115 of the switch 103, or another component of the switch 103.

After dividing the number of unique source IP addresses observed on ingress ports 106 of the switch 103 by the number of unique source IP addresses observed on egress ports 106 of the switch 103, the result of the division may be compared to a flow ratio threshold. The flow ratio threshold may be a number which is saved in memory 118 of the switch 103 as threshold data 124. The measurements of the num_dest_ip_x from received ports and/or the num_dest_ip_x to sent ports may also be saved to memory 118 as flow data 130.

The flow ratio threshold may be user-configurable and/or may be hardware-coded using logic circuitry in various implementations. For example, a user may be enabled to adjust contents of the threshold data 124 in memory 118 by editing a configuration file.

In some implementations other factors may be weighed in making the determination as to whether to switch adaptive routing techniques in addition to or instead of determining whether the ingress-to-egress flow ratio is below the flow ratio threshold.

As an example, and as described in greater detail below in relation to FIG. 6, the switch may also determine if a total egress bandwidth is relatively low in some implementations. The determination as to whether the ingress-to-egress flow ratio is below a flow ratio threshold may be determined only in response to first determining the total egress bandwidth is relatively low, for example less than a bandwidth threshold.

In some implementations, in addition to or instead of determining whether the ingress-to-egress flow ratio is below the flow ratio threshold, a current number of flows may be compared to a number of active ports. If the ratio of the total number of flows to the total number of active ports is less than a flow ratio threshold, then the switch 103 may determine the adaptive routing technique should be switched, for example from a spray adaptive routing technique to a sticky adaptive routing technique.

If, at 306, the switch determines the ingress-to-egress flow ratio is not below the flow ratio threshold, the method 300 may continue with the switch continuing to route data using the spray adaptive routing technique at 303.

At 309, the switch 103 may switch the routing of data from using a spray adaptive routing technique to using a sticky adaptive routing technique. As should be appreciated, the switch of routing the data using a spray adaptive routing technique to a sticky adaptive routing technique may be in response to detecting the ratio of ingress flows to egress flows is below the flow ratio threshold and/or in response to other determinations and/or calculations.

After switching to routing the data using the sticky adaptive routing technique, ports 106 may be allocated to one or more flows of data. With the sticky adaptive routing technique, only a portion of the ports 106 of the switch 103 may be utilized at any given time. After a period of time in which the switch 103 is using the sticky adaptive routing technique, one or more ports 106 of the switch 103 which are not being used may enter a sleep mode. As a result, the switch 103 may consume less power as compared to a switch using a spray adaptive routing technique to transmit the same data.

As illustrated in FIG. 4, a switch 103 may perform a method 400 involving dynamically switching from routing data using a first adaptive routing technique to routing data using a second adaptive routing technique. In the example method 400 illustrated in FIG. 4, the method 400 involves switching from a sticky adaptive routing technique to a spray adaptive routing technique in response to determining an egress bandwidth is greater than a bandwidth threshold. However, it should be appreciated that similar methods may be implemented to switch to and from different adaptive routing techniques and/or in response to other factors and determinations.

The method 400 may begin at 403 by routing data using a sticky adaptive routing technique. As referenced above, routing the data using a sticky adaptive routing technique may involve forwarding packets across a plurality of active ports by allocating one or more ports to each flow traversing the switch 103. As new packets traversing the switch 103 are handled and prepared for transmission, each packet may be assigned to a port based on an allocation of a flow to which the packet belongs with the port. It should be appreciated, however, that in some implementations certain flows may be handled using one adaptive routing technique (e.g., a spray adaptive routing technique) while other flows may be handled using another routing technique (e.g., a sticky adaptive routing technique). In such implementations, the method 400 may be used to dynamically switch the adaptive routing techniques for any number of one or more flows traversing the switch, if not all flows.

At 406, the switch 103 may determine whether the total egress bandwidth of data from the switch 103 is greater than a bandwidth threshold. Determining whether the total egress bandwidth of data from the switch 103 is greater than a bandwidth threshold may involve monitoring an amount of data being sent from the switch 103 via one or more egress ports 106. In some implementations, the switch 103 may record a volume of outgoing traffic in bytes per second or another unit.

Using the amount of data being sent from the switch 103, the switch 103 may be enabled to determine an egress bandwidth. Determining the egress bandwidth may be performed in real-time or over a specified monitoring period. The switch 103 may determine the egress bandwidth by summing bandwidth usage across each of the egress ports 106 of the switch 103. Bandwidth determinations may be stored in memory 118 as bandwidth data 127. For example, the switch 103 may record historical bandwidth levels into memory 118. In some implementations, the method 400 may be applied to a subset of ports 106. In such implementations, the switch 103 may ignore one or more of the ports 106 in calculating the egress bandwidth.

After determining the egress bandwidth, the switch 103 may compare the egress bandwidth to a bandwidth threshold. The bandwidth threshold may be a value stored in memory 118 as a part of the threshold data 124. The bandwidth threshold may be a user-configurable value and/or may be hardware-coded using logic circuitry in various implementations. For example, a user may be enabled to adjust contents of the threshold data 124 in memory 118 by editing a configuration file.

If, at 406, the switch determines the egress bandwidth is not greater than the bandwidth threshold, the method 400 may continue with the switch continuing to route data using the sticky adaptive routing technique at 403.

At 409, the switch 103 may switch the routing of data from using the sticky adaptive routing technique to using a spray adaptive routing technique. As should be appreciated, the switch of routing the data using a sticky adaptive routing technique to a spray adaptive routing technique may be in response to detecting the total egress bandwidth of the switch 103 is greater than a bandwidth threshold and/or in response to other determinations and/or calculations.

After switching to routing the data using the spray adaptive routing technique, ports 106 which were previously allocated to one or more flows of data may begin to be used to transmit data associated with other flows. With the sticky adaptive routing technique, only a portion of the ports 106 of the switch 103 may have been utilized at any given time and other ports 106 may be in a sleep mode. After switching to a spray adaptive routing technique, such ports 106 may be woken up and may begin to be used to transmit data from the switch 103, enabling the switch 103 to operate in an expanded capacity.

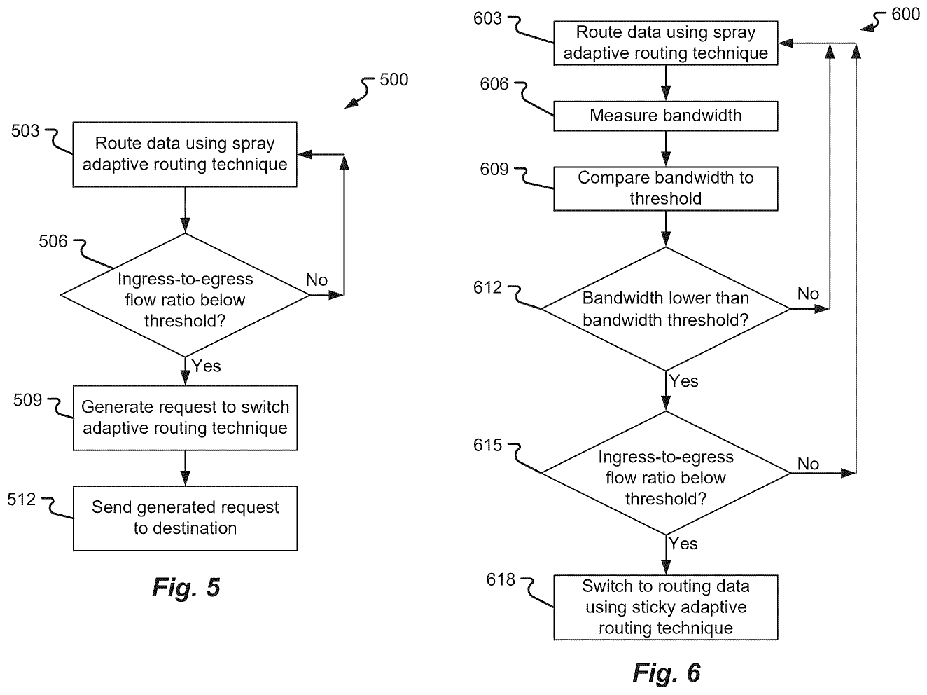

FIG. 5 and FIG. 6 illustrate methods 500 and 600, respectively, including variations on the implementation of the method 300 described above in relation to FIG. 3. In FIG. 5, as described in greater detail below, the switch 103 performing the method 300 switches to routing data using the sticky adaptive routing technique by communicating the switch to a remote device such as another switch 103. In FIG. 6, as described in greater detail below, the switch 103 performing the method 300 waits before determining whether the ingress-to-egress flow ratio is below the flow ratio threshold until the switch 103 first determines whether the total bandwidth is lower than a bandwidth threshold, similar to the step 406 of FIG. 4.

As illustrated in FIG. 5, a switch 103 may perform a method 500 involving dynamically deciding to prompt another device, such as another switch 103, to switch from routing data using a first adaptive routing technique to routing data using a second adaptive routing technique. In the example method 500 illustrated in FIG. 5, the method 500 involves generating and sending a request to the other device to request the other device switch from a spray adaptive routing technique to a sticky adaptive routing technique in response to determining an ingress-to-egress flow ratio is below a flow ratio threshold. However, it should be appreciated that similar methods may be implemented to request another device switch to and from different adaptive routing techniques and/or in response to other factors and determinations.

The other device which the switch 103 performing the method 500 requests switch adaptive routing techniques may in some implementations be a top-of-rack (ToR) switch or another type of switch. As a result of the method 500, the switch 103 sends a request or notification to the other device to request that any data sent by the other device to the switch 103 be sent using a sticky adaptive routing technique.

Like step 303 of method 300, the method 500 may begin by routing data using a spray adaptive routing technique at 503. As referenced above, routing the data using a spray adaptive routing technique may involve forwarding packets across a plurality of active ports. As new packets traversing the switch 103 are handled and prepared for transmission, each packet may be assigned to a port without allocating one or more ports to any specific flows.

At 506, the switch 103 may determine whether an ingress-to-egress flow ratio is below a flow ratio threshold, similar to step 306 of method 300. An ingress-to-egress flow ratio may be calculated by dividing a number of unique source IP addresses observed on ingress ports 106 of the switch 103 by a number of unique source IP addresses observed on egress ports 106 of the switch 103.

At 509, if the ingress-to-egress flow ratio is below the flow ratio threshold, the switch 103 may continue the method 500 by generating a request to send to a destination (such as another switch 103) at 509. The request may be instructions instructing the destination to switch adaptive routing technique. As an example, the instructions may request that the destination device switch from a spray adaptive routing technique to a sticky adaptive routing technique. If, on the other hand, the ingress-to-egress flow ratio is not below the threshold, the method 500 may continue with the switch continuing to route data using the spray adaptive routing technique.

At 512, the switch 103, after generating the request, may send the request to a destination. The request may be sent in the form of a packet or may be in the form of contents injected into a packet. For example, the switch 103 may generate the request by adding a flag to a header of a packet the switch 103 is preparing to transmit to the destination. The flag may signify to the destination that the destination should switch adaptive routing techniques.

After receiving the request to switch adaptive routing techniques, the destination device may switch to a sticky adaptive routing technique. As a result of switching to routing data using the sticky adaptive routing technique, ports of the destination device may be allocated to one or more flows of data. With the sticky adaptive routing technique, only a portion of the ports 106 of the destination device may be utilized at any given time. After a period of time in which the destination device is using the sticky adaptive routing technique, one or more ports of the destination device which are not being used may enter a sleep mode. As a result, the destination device may consume less power as compared to a switch using a spray adaptive routing technique to transmit the same data.

While the method 500 is described in relation to generating and sending a single request to a single destination, it should be appreciated that the same or similar methods may be implemented in which one or more requests are generated and sent to a number of different destination devices. Also, in some implementations, the switch 103 may, before, simultaneous with, or after sending the request, change its own adaptive routing technique. For example, the switch may identify the ingress-to-egress flow ratio is below the flow ratio threshold and in response switch its adaptive routing technique to a sticky adaptive routing technique and also generate and send a request to one or more destinations to request the destination(s) also switch adaptive routing techniques to sticky adaptive routing techniques.

As illustrated in FIG. 6, a switch 103 may perform a method 600 involving dynamically switching from routing data using a first adaptive routing technique to routing data using a second adaptive routing technique. In the example method 600 illustrated in FIG. 6, the method 600 involves switching from a spray adaptive routing technique to a sticky adaptive routing technique in response to determining a total egress bandwidth is lower than a bandwidth threshold and in response to determining an ingress-to-egress flow ratio is below a flow ratio threshold. It should, however, be appreciated that similar methods may be implemented to switch to and from different adaptive routing techniques and/or in response to other factors and determinations.

The method 600 may begin at 603, in which a switch 103 is routing data using a spray adaptive routing technique as described above, similar to the method 300 of FIG. 3. As referenced above, routing the data using a spray adaptive routing technique may involve forwarding packets across a plurality of active ports. As new packets traversing the switch 103 are handled and prepared for transmission, each packet may be assigned to a port without allocating one or more ports to any specific flows. It should be appreciated, however, that in some implementations certain flows may be handled using one adaptive routing technique (e.g., a spray adaptive routing technique) while other flows may be handled using another routing technique (e.g., a sticky adaptive routing technique). In such implementations, the method 600 may be used to dynamically switch the adaptive routing techniques for any number of one or more flows traversing the switch, if not all flows.

At 606, the switch 103 may measure a current egress bandwidth of data transmitting from the switch 103. The switch 103 may monitor an amount of data being sent from the switch 103 via one or more egress ports 106. In some implementations, the switch 103 may record a volume of outgoing traffic in bytes per second or another unit.

Using the amount of data being sent from the switch 103, the switch 103 may be enabled to determine a current egress bandwidth. Determining the egress bandwidth may be performed in real-time or over a specified monitoring period. The switch 103 may determine the egress bandwidth by summing bandwidth usage across each of the egress ports 106 of the switch 103. Bandwidth determinations may be stored in memory 118 as bandwidth data 127. For example, the switch 103 may record historical bandwidth levels into memory 118. In some implementations, the method 600 may be applied to a subset of ports 106. In such implementations, the switch 103 may ignore one or more of the ports 106 in calculating the egress bandwidth.

After measuring the current egress bandwidth at 606, the switch 103 may compare the egress bandwidth to a bandwidth threshold at 609. The bandwidth threshold may be a value stored in memory 118 as a part of the threshold data 124. The bandwidth threshold may be a user-configurable value and/or may be hardware-coded using logic circuitry in various implementations. For example, a user may be enabled to adjust contents of the threshold data 124 in memory 118 by editing a configuration file.

At 612, the switch 103 may determine whether the egress bandwidth is lower than the bandwidth threshold. If, at 612, the switch determines the egress bandwidth is not lower than the bandwidth threshold, the method 600 may continue with the switch continuing to route data using the spray adaptive routing technique at 603. If, on the other hand, the egress bandwidth is lower than the bandwidth threshold at 612, the method 600 may continue with the switch determining, at 615, whether the ingress-to-egress flow ratio is below a flow ratio threshold.

Similar to the step 306 of method 300, the switch 103 may, at 615, determine whether an ingress-to-egress flow ratio is below a flow ratio threshold. An ingress-to-egress flow ratio may be calculated by dividing a number of unique source IP addresses observed on ingress ports 106 of the switch 103 by a number of unique source IP addresses observed on egress ports 106 of the switch 103.

Determining whether the ingress-to-egress flow ratio is below the flow ratio threshold may include monitoring ingress and egress traffic. For example, the switch 103 may record source and/or destination IP addresses of packets received and transmitted by the switch 103. The switch 103 may maintain a count of such IP addresses and use the count of IP addresses to make the determination as to whether the ingress-to-egress flow ratio is below the threshold.

In some implementations, determining the num_dest_ip_x from received ports and/or num_dest_ip_x to sent ports may involve polling contents of one or more queues 121. The determination of the num_dest_ip_x from received ports and/or num_dest_ip_x to sent ports may be performed by switching hardware 109 of the switch 103, processing circuitry 115 of the switch 103, or another component of the switch 103.

After dividing the number of unique source IP addresses observed on ingress ports 106 of the switch 103 by the number of unique source IP addresses observed on egress ports 106 of the switch 103, the result of the division may be compared to a flow ratio threshold. The flow ratio threshold may be a number which is saved in memory 118 of the switch 103 as threshold data 124. The measurements of the num_dest_ip_x from received ports and/or the num_dest_ip_x to sent ports may also be saved to memory 118 as flow data 130.

The flow ratio threshold may be user-configurable and/or may be hardware-coded using logic circuitry in various implementations. For example, a user may be enabled to adjust contents of the threshold data 124 in memory 118 by editing a configuration file.

In some implementations other factors may be weighed in making the determination as to whether to switch adaptive routing techniques in addition to or instead of determining whether the ingress-to-egress flow ratio is below the flow ratio threshold.

As an example, and as described in greater detail below in relation to FIG. 6, the switch may also determine if a total egress bandwidth is relatively low in some implementations. The determination as to whether the ingress-to-egress flow ratio is below a flow ratio threshold may be determined only in response to first determining the total egress bandwidth is relatively low, for example less than a threshold bandwidth.

In some implementations, in addition to or instead of determining whether the ingress-to-egress flow ratio is below the flow ratio threshold, a current number of flows may be compared to a number of active ports. If the ratio of the total number of flows to the total number of active ports is less than a flow ratio threshold, then the switch 103 may determine the adaptive routing technique should be switched, for example from a spray adaptive routing technique to a sticky adaptive routing technique.

In the method 600, the determination as to whether the ingress-to-egress flow ratio is below the flow ratio threshold is made only in response to determining the current bandwidth is lower than the bandwidth threshold. It should be appreciated, however, that in other implementations the determination as to whether the current bandwidth is lower than the bandwidth threshold may be made in response to the determination as to whether the ingress-to-egress flow ratio is below the flow ratio threshold. As should be appreciated other implementations may involve other determinations or any combination thereof.

At 618, the switch 103 may switch the routing of data from using a spray adaptive routing technique to using a sticky adaptive routing technique. As should be appreciated, the switch of routing the data using a spray adaptive routing technique to a sticky adaptive routing technique may be in response to detecting the bandwidth is lower than the bandwidth threshold and the ratio of ingress flows to egress flows is below the flow rate threshold.

After switching to routing the data using the sticky adaptive routing technique, ports 106 may be allocated to one or more flows of data. With the sticky adaptive routing technique, only a portion of the ports 106 of the switch 103 may be utilized at any given time. After a period of time in which the switch 103 is using the sticky adaptive routing technique, one or more ports 106 of the switch 103 which are not being used may enter a sleep mode. As a result, the switch 103 may consume less power as compared to a switch using a spray adaptive routing technique to transmit the same data.

It is to be appreciated that any feature described herein can be claimed in combination with any other feature(s) as described herein, regardless of whether the features come from the same described embodiment.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A system for providing adaptive routing, the system comprising one or more circuits to:
route data using a first adaptive routing technique;
detect a ratio of ingress flows to egress flows is below a threshold; and
in response to detecting the ratio of ingress flows to egress flows is below the threshold, switch from routing the data using the first adaptive routing technique to routing the data using a second adaptive routing technique.

2. The system of claim 1, wherein the one or more circuits are further to measure a current bandwidth and compare the current bandwidth to a bandwidth threshold.

3. The system of claim 2, wherein detecting the ratio of ingress flows to egress flows is below the threshold is performed in response to determining the current bandwidth is lower than the bandwidth threshold.

4. The system of claim 1, wherein routing the data using the first adaptive routing technique comprises forwarding packets across a plurality of active ports and wherein the second adaptive routing technique comprises allocating a single port for each of one or more flows of the data.

5. The system of claim 1, wherein switching from routing the data using the first adaptive routing technique to routing the data using the second adaptive routing technique comprises generating a request and sending the request to a destination.

6. The system of claim 5, wherein the destination is a top-of-rack switch.

7. The system of claim 1, wherein after switching to routing the data using the second adaptive routing technique, one or more ports enter a sleep mode.

8. The system of claim 1, wherein, after switching to routing the data using the second adaptive routing technique, the one or more circuits are further to:
determine a total bandwidth is greater than a total bandwidth threshold; and
in response to determining the total bandwidth is greater than the total bandwidth threshold, switch the routing of the data from the second adaptive routing technique to the first adaptive routing technique.

9. The system of claim 1, wherein the ratio of ingress flows to egress flows is associated with a port of the system.

10. A switch comprising one or more circuits to:
route one or more egress flows of packets using a first adaptive routing technique;
detect a ratio of ingress flows to the one or more egress flows is below a threshold; and
in response to detecting the ratio of ingress flows to the one or more egress flows is below the threshold, switch from routing the one or more egress flows of packets using the first adaptive routing technique to routing the one or more egress flows of packets using a second adaptive routing technique.

11. The switch of claim 10, wherein the one or more circuits are further to measure a current bandwidth and compare the current bandwidth to a bandwidth threshold.

12. The switch of claim 11, wherein detecting the ratio of ingress flows to egress flows is below the threshold is performed in response to determining the current bandwidth is lower than the bandwidth threshold.

13. The switch of claim 10, wherein routing the one or more egress flows using the first adaptive routing technique comprises routing packets across a plurality of active ports and wherein the second adaptive routing technique comprises allocating a single port to each of the one or more egress flows.

14. The switch of claim 10, wherein switching from routing the one or more egress flows of packets using the first adaptive routing technique to routing the one or more egress flows of packets using the second adaptive routing technique comprises generating a request and sending the request to a destination.

15. The switch of claim 14, wherein the destination is a top-of-rack switch.

16. The switch of claim 10, wherein after switching to routing the one or more egress flows using the second adaptive routing technique, one or more ports of the switch enter a sleep mode.

17. The switch of claim 10, wherein, after switching to routing the one or more egress flows of packets using the second adaptive routing technique, the one or more circuits are further to:
determine a total bandwidth is greater than a total bandwidth threshold; and
in response to determining the total bandwidth is greater than the total bandwidth threshold, switch the routing of the flows of packets from the second adaptive routing technique to the first adaptive routing technique.

18. A method for providing adaptive routing, the method comprising:
routing data using a first adaptive routing technique;
detecting a ratio of ingress flows to egress flows is below a threshold; and
in response to detecting the ratio of ingress flows to egress flows is below the threshold, switching from routing the data using the first adaptive routing technique to routing the data using a second adaptive routing technique.

19. The method of claim 18, further comprising measuring a current bandwidth and comparing the current bandwidth to a bandwidth threshold.

20. The method of claim 19, wherein detecting the ratio of ingress flows to egress flows is below the threshold is performed in response to determining the current bandwidth is lower than the bandwidth threshold.
